(19) United States
(12) Patent Application Publication
(10) Pub. No.: US 2007/0087210 A1
(43) Pub. Date: Apr. 19, 2007

(54) High temperature insulative coating (XTR)

(76) Inventors: Purusottam Sahoo, Sugar Land, TX (US); Shane M. Richard, Deer Park, TX (US); Cyril Stephen Magda JR., Magnolia, TX (US); Gary Dennis Logan, Seabrook, TX (US)

Correspondence Address: Francis C. Hand, Esq.;Carella, Byrne, Bain, Gilfillan,, Cecchi, Stewart & Olstein, 5 Becker Farm Road, Roseland, NJ, 07068, US

(21) Appl. No.: 10/758,565

(22) Filed: Jan. 15, 2004

(51) Int. Cl. B32B 15/04; B32B 9/00

(52) U.S. Cl. 428/469; 428/471; 428/472

(57) ABSTRACT

A thermal barrier coating with unique properties suitable for high temperature thermal insulation control on a substrate is provided. The coating is thermally sprayed, consisting of three layers: 1) a MCrAIY bond coat (basecoat), 2) an intermediate crack resistant ceramic coating, and 3) a top coat of yttria stabilized zirconia. The three layer coating is deposited, preferably, using an air plasma spray system with suitable macro cracks in the top coat, with an underlying crack resistant layer, to enable the ceramic top coat to have properties suitable for advanced gas turbine thermal barrier coatings.

This invention relates to a high temperature insulative coating. More particularly, this invention relates to a thermally insulative coating for gas turbines. Still more particularly, this invention relates to a thermally insulative coating for gas turbines having a cracked top coat.

### BACKGROUND

In order to increase the efficiency of gas turbines, the firing temperature must be increased. Current advanced technology heavy frame gas turbines (i.e., GE Frame FA and beyond; Siemens-Westinghouse 501G and beyond) operate at temperatures well above the design limits of many alloys. This is possible only because thermal barrier coatings (TBC) are applied onto the gas path surfaces that are exposed to high temperatures. Typically, the highest temperatures in a gas turbine occur in the turbine section where rotating blades (sometimes called “buckets”) spin at high rpm against a “shroud” supported by an engine case.

Because of the high temperature, only certain refractory ceramic materials with properties compatible with the base superalloy can be used as a TBC. Properties that the ceramic material must possess include, but are not limited to:

Resistance to sintering at high temperature

Resistance to repetitive (or, cyclic) heating and cooling

Low thermal conductivity

Resistance to spallation (delamination) from the bond coat

Matching COE (Coefficient of expansion) to bond coat and base material

Typically, for thermal insulation applications, zirconia based coatings (colloquially called YSZ: Yttria partially Stabilized Zirconia) have been used for decades. There are other compositions that are continually being researched and tested as alternatives to YSZ. In actual production, however, there have been very few alternates to this coating. However, if such a composition is found, the findings of this will be applicable to these new compositions. Although there are numerous patents and publications (numbering in the thousands) on the efficacy of this and other materials, the YSZ continues to be predominantly used. However, for those skilled in the art, it is well known that under certain conditions, yttria may be replaced, fully or partially, by oxides such as ceria, india, scandia, lanthania, and the like.

It is known in the art of gas turbine coatings that the desirable properties of a coating are dependent on a variety of factors, including chemical composition, method of application, coating porosity, thickness of the coating, and the existence of cracks (microcracks and macrocracks) in the deposited coating layer(s). It is known that the insulative property is linearly dependent on the thickness of the coating. In addition, the insulative property is a function of the coating microstructure. Typically, for thermal insulation applications, zirconia based coatings have been used for decades. However, in advanced gas turbines, the designer needs more than an insulative coating. The coating must also be cost effective in a production mode and compatible with the rotating member.

In their efforts to produce useful thermal barrier coatings, most coating applicators have utilized a two layer coating system. Typically, the coating system consists of a MCrAlYX (M=Ni or Co or both; X═Hf, Zr, Si, or combinations thereof, or other reactive elements) bond coat and a Zr0₂-Y₂0₃ topcoat. The bond coat acts to provide good adhesion between the metal substrate and the ceramic top coat, while providing good oxidation protection to the underlying substrate alloy. The top coat acts as a heat shield, insulating the substrate alloy; therefore allowing higher operating temperatures and/or reductions in cooling requirements. Numerous studies have shown that the composition and physical characteristics of both the bond coat and the top coat are extremely important in producing a superior thermal barrier coating.

Both the aerospace and stationary gas turbine engine manufacturers have settled on two basic formulations of the MCrAlY bond coat, which are: 1) 38.5Co-32Ni-2ICr-8Al-O.5Y, and 2) 47Ni-23Co-17Cr-I2.5Al-O.5Y. There are many other MCrA1Y formulations designed for service specific needs. These various MCrAlY coatings are chosen based upon their resistance to hot corrosion [Type I and Type II], oxidation, and high temperature mechanical properties. However, those skilled in the art will realize that there are other types of MCrAlY coatings that can be effectively used. Examples of such coatings are found in U.S. Pat. No. 4,585,481 that describes a NiCoCrAlY+Hf+Si coating. The additions of other elements, such as hafnium and silicon, are sometimes called reactive element additions. These help in resisting oxidation and improve the life of the bond coat.

The most common top coat material used for a thermal barrier is a nominal 8% yttria partially stabilized zirconia powder.

In applying a typical TBC, both the bond coat and top coat are air plasma sprayed (APS) to specified thickness' and microstructural requirements. The porosity of the top coat is controlled to maximize thermal cycle lifetime.

Recently, there has been a flurry of activity in creating so-called macro-cracked TBCs. Unlike a standard APS TBC, these have vertical macrocracks (these are defined. as those cracks that are greater than 0.004″ in length, and predominantly oriented normal to the surface of the part coated) that are hypothesized to assist under severe thermal stresses. Such APS TBC try and simulate the microstructure obtained by using the so-called EB-PVD (Electron Beam-Physical Vapor Deposition) TBC deposition method. Such a deposition method creates a “columnar” type TBC structure. Various publication claim that such a structure contributes to the prolonged lifetime under severe thermal cycles. However, EB-PVD deposition methods have certain disadvantages, namely, they are very expensive to run, and secondly, the vacuum deposition chambers required for such a method are not easily amenable for large industrial gas turbine parts. It has long been desired to obtain the type of TBC structure obtained in an EB-PVD method by utilizing more commercial and less expensive processes. Air plasma sprayed TBC is one such method and has to a degree simulated the structure obtained by the more expensive EB-PVD method. Many patents have been published on this subject. In these coatings, the density of the coating, the length and spacing of the vertical cracks, and the presence and nature of any horizontal cracks all contribute to the performance of the coating. In circumstances where the APS method is not suitable, the EB-PVD method may be employed.

The following literature is cited as prior art.

U.S. Pat. No. 4,861,618 describes a method of applying a TBC which includes an air plasma sprayed NiCoCrA1Y bond coat and an air plasma sprayed zirconia top coat.

U.S. Pat. No. 4,457,948 describes a process of applying and heat treating a TBC to form a multiplicity of cracks.

U.S. Pat. No. 5,073,433 describes a dense TBC with vertical macro cracks.

U.S. Pat. No. 5,281,487 describes a graded TBC with more than two layers.

U.S. Pat. No. 5,514,482 describes a columnar grained TBC on top of a diffusion aluminide bond coat.

U.S. Pat. No. 5,520,516 describes a gas turbine blade tip with a TBC having a vertical macrocracked structure.

U.S. Pat. No. 5,681,616 describes a TBC which is subsequently segmented by selectively forming a grid pattern comprising grooves.

U.S. Pat. No. 5,743,013 describes a gas turbine blade tip with a TBC having a vertical macrocracked structure.

U.S. Pat. No. 5,830,586 describes a TBC with columnar structure.

U.S. Pat. No. 5,989,343 describes a TBC that is directionally solidified.

U.S. Pat. No. 5,993,976 describes a strain tolerant ceramic coating.

U.S. Pat. No. 6,047,539 describes a dense vertical cracked coating for protecting combustor components.

U.S. Pat. No. 6,432,487 describes a dense vertically cracked coating with an outer sacrificial coating.

The above cited documents, almost exclusively, deal with modifying the microstructure of a coating so as to obtain cracks that are predominantly oriented in the vertical direction, i.e. perpendicular to the plane of the substrate that is coated. It is suggested, that since the cracks are vertically oriented, repetitive heating and cooling will lead to crack propagation. Since the cracks are mostly exposed to the free top surface, they will propagate in a direction towards the substrate. In most cases, the top coat will be sprayed on top of a metallic bond coat. If and when the multiple cracks propagate and reach the bond coat surface, the risk of coating delamination will occur. However, any delamination of the TBC will lead to significant reduction in the thermal insulative property of the coating. This can lead to catastrophic results if the underlying base material is not suitably protected.

Accordingly, it is the object of this invention to resist, or prolong, the crack propagation to the bond coat surface of a vertically cracked coating.

It is another object of the invention to provide a thermal barrier coating that is vertically cracked and resistant to delamination.

Briefly, the invention provides a thermal barrier coating for a substrate comprised of a MCrAlY bond coat; an intermediate crack resistant ceramic coating on the bond coat; and a vertically cracked top coat of yttria stabilized zirconia on the intermediate coat. The intermediate layer can be created by applying a layer of material similar to the dense vertical cracked top coat that contains crack inhibiting pores.

The improved thermal insulative coating can be applied by processing as follows:
1. Apply a bond coat containing Ni, Co, Cr, Al, Y and other reactive elements such as Hf, Si.
2. Apply a crack resistant TBC predominantly constituting YSZ, but may contain polyester to form suitable crack resistant pores. This coating is applied so as to adhere strongly to the underlying bond coat. The thickness may range from 0.002 to 0.010 inch, preferably 0.004 to 0.006 inch.
3. Apply a dense vertically cracked coating for resistance to strain induced by repetitive heating and cooling cycles. The thickness of this coating will be suitable for the specific application in high temperature hot section components, such as rotating blades and stationary vane segments.

The application of a crack resistant TBC followed by a dense vertically cracked coating results in a combination that substantially enhances the thermal insulative property of coatings used in high temperature hot section components.

The following examples demonstrate the scope of the invention

The bond coat is a MCrAlY, described earlier and is typically about 0.003 to 0.010 inch thick.

The intermediate layer is a YSZ (Zirconia-Yttria) that is preferably about 0.002 to 0.006 inches thick with a controlled amount of porosity to resist crack propagation.

The top layer is also a YSZ that is applied to a thickness that will determine the total YSZ coating thickness. Preferably, this will be a (total) thickness of the order of 0.010 to 0.050″ thick. Thus, if the intermediate YSZ layer is 0.005″ thick, the top coat will be 0.005 to 0.045″ thick.

For the bond coat, such as for the 365-2 powder, the following spray parameters have been found useful:

Bond Coat

Powder: Amdry 365-2

Gun: 9MB or 3MBT,

GP nozzle, 9MB63/3MB63 electrode

Argon/Hydrogen

Argon: 80 scfh@80 psi

Hydrogen: Adjust to get 68-69V@console

Spray distance: 4-4.25″

Amps: 500

Feed rate: 35 g/min

For the intermediate, crack-resistant ceramic coating, commercially available powder from Sulzer Metco (SM 2460) which consisted of primarily YSZ (Yttria Stabilized Zirconia) and 3% polyester was used. The commercially obtainable Sulzer Metco 2460NS powder is further described in co-pending U.S. patent application Ser. No. 10/728,014, filed Dec. 4, 2004 and entitled High Temperature Clearance Coating.

The powder was a mechanical blend that was sprayed using a standard Metco 9MB plasma spray gun.

The parameters for the spray gun used to apply the intermediate coat were as follows:

| Primary Gas | Nitrogen |
|---|---|
| Secondary Gas | Hydrogen |
| Plasma Gun Type | 9MB |
| Nozzle | 730 |
| Powder Port # | 2 |
| Amps | 500 |
| Volts | 77 |
| Primary (psi/fmr) | 48/75 |
| Secondary (psi/fmr) | 50/18 |
| Carrier (psi/fmr) | 40/13 |
| Powder Feed Rate (g/min) | 50 |
| Pick-Up Shaft Type | C |
| Vibrator Setting | 20 |
| Spray Distance (in.) | 4.5 |

The top coat, with the vertical cracks, was applied using a ZY-7 zirconia-yttria powder. A certificate of analysis (composition, size distribution) is attached as Exhibit 1.

The spray conditions found useful are:
Gun: 9MB with G nozzle and 9MB63 electrode
Amps: 575±5
Volts@console: 80 V minimum
Primary gas: N₂@50 psi; Flow@80 scfh
Secondary gas: H₂: Adjust to obtain desired voltage; 60 psi setting
Top coat powder feed rate: 30 grams/minute
Spray distance: 3 inch

As can be seen above, the bond coat, intermediate coat, and top coat may use similar spray guns, but the actual settings differ. Unlike the intermediate and top layer ceramic coatings, the MCrAlY bond coat may be applied via a variety of methods—these include Twin Wire Arc Spray, HVOF (High Velocity Oxy Fuel), Plasma, VPS (Vacuum Plasma Spray), or any other method whereby a suitable microstructure may be obtained.

The final ceramic top coat may also be applied via EB-PVD method if so desired.

Each method has its own advantages and disadvantages, and one skilled in the art of spraying MCrAlY coatings can decipher what method may be utilized depending on the application intended for the coating.

Typically, for both bond and top coats, the powder feed rate and the relative motion between the spray gun and part is so adjusted as to give a thin lamellar coating per pass. Typically, bond coats are applied between 0.0005 to 0.002 inch per pass, and the top coat is about twice that. Desirable properties of the bond coat include:

Low oxide level

High roughness

High density

The part maybe pre-heated to about several hundred degrees Fahrenheit before applying the top coat.

Since the previously known coatings do not have an intermediate layer, once the top coat begins to propagate, a crack will lead to the bond coat/top coat interface and delaminate. This will expose the turbine blade/bucket to high temperatures and premature risk of failure or rapid degradation of service life.

The present invention interjects an intermediate layer between the bond coat and the top coat that will prevent the crack from propagating through the top coat to the interface. Further, even if the top layer delaminates, a second “defensive” ceramic layer will prevent/reduce catastrophic failure of the turbine blade/bucket.

The invention thus provides the combination of a top coat with vertically oriented cracks and a crack resistant intermediate under layer. The thermal barrier coating is particularly useful on high temperature superalloys as used in gas turbines to insulate the substrate material from the high gas temperature.

1. A thermal barrier coating for a substrate, said coating comprising
a MCrAlY bond coat wherein M is at least one of Ni and Co;
an intermediate crack resistant ceramic coating on said bond coat; and
a vertically cracked top coat of yttria stabilized zirconia on said intermediate coat.

2. A thermal barrier coating as set forth in claim 1 wherein said intermediate coating includes a plurality of pores therein to resist crack propagation.

3. A thermal barrier coating as set forth in claim 2 wherein said intermediate coating includes polyester.

4. A thermal barrier coating as set forth in claim 1 wherein said intermediate coating has thickness of from 0.002 to 0.010 inch.

5. A thermal barrier coating as set forth in claim 2 wherein said intermediate coating has a thickness of from 0.004 to 0.006 inch.

6. A thermal barrier coating as set forth in claim 2 wherein said bond coat has a thickness of from 0.003 to 0.010 inch, said intermediate coating has a thickness of from 0.002 to 0.006 inch and said top coat has a thickness of from 0.005 to 0.045 inch.

7. A thermal barrier coating for a substrate, said coating comprising
a bond coat made of NiCoCrAlY;
an intermediate crack resistant ceramic coating on said bond coat having a thickness of from 0.002 to 0.010 inch; and
a vertically cracked top coat of yttria stabilized zirconia on said intermediate coat

8. A thermal barrier coating as set forth in claim 7 wherein said bond coat contains a reactive element selected from the group consisting of hafnium and silicon.

9. A coated substrate comprising
a substrate;
a bond coat on said substrate comprised of a high temperature MCrAlY wherein M is at least one of Ni and Co and having a thickness of from 0.003 to 0.010 inch,
an intermediate crack resistant ceramic coating containing yttria stabilized zirconia on said bond coat of a thickness of from 0.002 to 0.006 inch; and
a vertically cracked top coat on said bond coat comprised of high temperature yttria stabilized zirconia of a thickness of from 0.005 inches to 0.045 inches.

10. A coated substrate as set forth in claim 9 wherein said substrate is an inner shroud cover plate.

11. A coated substrate as set forth in claim 9 wherein said substrate is one of a turbine rotating blade, turbine bucket, stationary vane and nozzle segment.
